(19) United States
(12) Patent Application Publication
(10) Pub. No.: US 2010/0247868 A1
(43) Pub. Date: Sep. 30, 2010

(54) POLYURETHANE POROUS PRODUCT AND MANUFACTURING METHOD THEREOF AND POLISHING PAD HAVING POLYURETHANE POROUS PRODUCT

(75) Inventors: Yoon Jong CHA, Incheon Metropolitan City (KR); Ho Chahn HAHN, Suwon-si (KR); Min Chul CHO, Gunpo-si (KR)

Correspondence Address: AMPACC Law Group, 3500 188th Street S.W., Suite 103, Lynnwood, WA, 98037, US

(73) Assignees: Yoon Jong CHA, Incheon Metropolitan City (KR); DONG SUNG A&T CO., LTD., Yongin-si (KR)

(21) Appl. No.: 12/730,631

(22) Filed: Mar. 24, 2010

(30) Foreign Application Priority Data
Mar. 24, 2009 (KR) 10-2009-0025079

(51) Int. Cl. B24D 11/00; B24D 3/00; B24D 11/02; B32B 3/30; B32B 27/40; B32B 7/02

(52) U.S. Cl. 428/160; 51/296; 51/295; 428/304.4; 428/217

(57) ABSTRACT

The present invention relates to a method for manufacturing a polyurethane porous product, a polyurethane porous product according to the manufacturing method, and a polishing pad having the polyurethane porous product. According to the present invention, it is possible to manufacture a polishing pad that has excellent polishing efficiency and has a minimal difference in the polishing characteristic during a polishing process and improves uniformity in plane of material that will be polished because the polyurethane porous product of the present invention has small density difference, small hardness difference, and the stabilized quality of material.

### BACKGROUND OF THE INVENTION

1. Field of the Invention

The present invention relates to a method for manufacturing a polyurethane porous product, a polyurethane porous product according to the manufacturing method, and a polishing pad having the polyurethane porous product. More particularly, the present invention pertains to a method for manufacturing a polyurethane porous product for a polishing pad that is used to polish and planarize semiconductor wafers, flat displays such as LCDs, LED, precision instruments such as optical lens, glass substrates for hard disks and the like, a polyurethane porous product according to the manufacturing method, and a polishing pad having the polyurethane porous product.

2. Description of the Related Art

A general chemical mechanical polishing/planarization (CMP) device of semiconductor wafer simultaneously performs mechanical polishing by friction of the polishing pad and the semiconductor wafer and chemical polishing by chemical components of a polishing slurry by continuously providing the polishing slurry while a load is applied to a wafer carrier and a turn table is rotated after the semiconductor wafer is disposed on the upper part of the polishing pad.

Herein, the wafer carrier functions to transport the wafer and the polishing slurry supply part functions to provide polishing slurry.

The polishing slurry, in general, is a high alkaline aqueous solution in which colloidal silica, fumed silica or cerium oxide are in potassium hydroxide (KOH) or ammonium hydroxide (NH₄OH) as a solvent in a concentration of 10 to 20% and the pH is adjusted to 10 to 12, and helps mechanical polishing of polishing particles, and the high alkaline aqueous solution performs chemical polishing.

The polishing pad that is disclosed in WO 1994/04599 is manufactured by adding an expanded organic polymer hollow structure to an isocyanate group end urethane prepolymer, uniformly mixing them, and cutting a mold sheet that is mixed with 4,4-methylene-bis(2-chloroaniline) (MOCA) that is an active hydrogen group-containing compound as a curing agent and cured in a predetermined thickness, and since it has high surface hardness, compression deformability is low and a polishing rate and planarization property are excellent. However, since the expanded organic polymer hollow structure beforehand has very low specific gravity of 0.042, it has a very large difference in specific gravity of the isocyanate group end urethane prepolymer, the mixture including them is easily phase separated and combination deviation may easily occur in its discharged solution. Accordingly, when the mixed and agitated resin composition solution is injected into a mold and molded, a phenomenon occurs in which the expanded fine hollow structure floats before the resin is cured and disposed at the upper side. Therefore, the polishing pad that is obtained by horizontally slicing the molded material and has a predetermined thickness has problems in that a difference in density and hardness occurs at the upper part and the lower part, its quality is degraded because the material does not have uniform properties, and a characteristic deviation occurs between lots of the polishing pads.

In addition, there is a disadvantage in that since the organic hollow structure is composed of a central part including hydrocarbon having a low boiling point and an outer part including thermoplastic resins of acrylonitrile-vinylidene chloride copolymer or acrylonitrile copolymer, when the polishing is performed, a scratch may occur due to the thermoplastic resin of air holes.

Korean Patent No. 10-0418649 discloses a polyurethane porous product for a polishing pad that is obtained by putting the mixture solution of an isocyanate group end urethane prepolymer and an expanded organic polymer hollow structure or non-expanded organic polymer hollow structure into a first tank, maintaining the temperature at 70° C., maintaining the temperature of 4,4-methylene-bis(2-chloroaniline) (MOCA) that is a curing agent at 120° C. in a second tank, maintaining the temperature of a predetermined amount of water at a normal temperature in a third tank, mixing and agitating the three solutions with each other at a high speed, and curing them.

The polyurethane porous product for a polishing pad has disadvantages in that the differences in density, hardness, and physical properties of the polishing pad occurs because of the difference in specific gravity between the urethane prepolymer and the hollow structure, the air hole that is formed by reacting water and the urethane prepolymer when water is injected into the separate third tank becomes unstable because of an effect of the organic polymer hollow structure having low specific gravity, and production efficiency is low.

WO 2001/96434 discloses a technology in which air holes are formed by injecting non-reactive gas into a polishing pad composition while a separate polymer hollow structure is not added. According to this, a first component solution is obtained by mixing an isocyanate group end prepolymer and a non-reactive silicon-based surfactant that does not include a hydroxyl group with each other, a cream type bubble dispersion solution is manufactured by injecting the non-reactive gas to the first component solution and agitating them at a high rate, and relative nonuniform and large bubbles are removed by passing them through a filtering net. The cream type bubble dispersion solution is put into a biaxial streamlined mixer, MOCA that is melted and warmed at about 120° C. is added thereto, mixed, added to a mold, and cured to manufacture a polyurethane foaming product for a polishing pad.

However, the polishing pad forms nonuniform and large bubbles in a process for manufacturing a cream type bubble dispersion solution, such that a polishing characteristic deviation occurs according to lot of the pad due to the nonuniform air holes. Accordingly, it is difficult to control the process and reliability of the product is reduced. Even though a filtering process for removing the nonuniform and large bubbles is added, there is a disadvantage in that it is difficult to obtain a desirable effect.

In addition, since the cream type bubble dispersion solution is manufactured by injecting the non-reactive gas to the isocyanate group end urethane prepolymer component, a mixing process of two components should be rapidly performed in order to minimize a change in physical properties of the composition.

That is, a negative effect may occur on preservation of the urethane prepolymer that is sensitive to the surrounding environment such as water, the production efficiency is low because of discontinuous formation of the air holes, and a deviation occurs according to the lot, such that it is difficult to manufacture reproducible products. In addition, since a boiling point of the curing agent is high, a nonionic silicon-based surfactant should be added to an isocyanate group end prepolymer. Therefore, in order to prevent reaction of the isocyanate group of the urethane prepolymer and the hydroxyl group of the silicon-based surfactant in the mixing process, there is a limit in that only non-reactive silicon-based surfactant that does not include the hydroxyl group should be selected and used.

WO 1994/04599, Korean Patent No. 10-0418649 and WO 2001/96434 disclose aromatic polyamine that is a solid at a normal temperature and has generally a boiling point of 90° C. or more as a curing agent that is an active hydrogen group-containing compound. In general, since the density is controlled by dissolving aromatic-based polyamine that is solid at a normal temperature at a high temperature of 110° C. or more, in the case of when a surfactant or an additive is mixed at this temperature, it is difficult to maintain a predetermined temperature and to control the viscosity, and there is a possibility of a change in physicochemical properties of the surfactant and additive.

Therefore, in the case of when other components are added thereto, there is a limit in that it should be mixed with the isocyanate group end urethane prepolymer, and the mixing with the urethane prepolymer that is sensitive to the surrounding environment such as water has a disadvantage in that there is a limit in the production stability and storage.

Meanwhile, Japanese Unexamined Patent Application Publication No. 2002-13445 discloses use of a urethane prepolymer into which a hydrophilic polyol is introduced in order to improve polishing efficiency by increasing the polishing slurry maintaining amount. In the polishing process, wettability of the polishing pad to the polishing slurry is important, if the wettability of the polishing pad is excessively high or hydrophilic unreacted components remain, the solution of the polishing slurry is absorbed on the surface of the polishing pad, such that the polishing pad is swollen, and uniformity in plane and stability of the polishing rate are lowered. The above patent has problems in that when hydrophilic polyol is reacted with the isocyanate group, unreacted polyol component may remain in the urethane prepolymer, and the unreacted polyol component acts as a factor for lowering physical properties.

In addition, when the chemical mechanical polishing/planarization (CMP) process is performed, the polishing is performed by injecting slurry that includes the abrasives between material that will be polished and the polishing pad. The slurry is composed of medical products such as an expensive abrasive, and a loss amount thereof is larger than a used amount due to a characteristic of the process where it is provided from the outside, and efficiency of the abrasive that is used in practice is low, such that a significant loss occurs in views of economic efficiency.

### SUMMARY OF THE INVENTION

In order to solve the above problems, it is an object of the present invention to provide a method for manufacturing a polyurethane porous product that uses aromatic polyamine, aliphatic amine or low molecular weight glycol as a liquid curing agent and includes water as a foaming promoter which reacts with isocyanate component so that the size of air hole is controlled, a polyurethane porous product which has the improved stability, uniformity in plane, and polishing efficiency of the material according to the manufacturing method, and a polishing pad having the polyurethane porous product.

In order to accomplish the above object, the present invention provides a method for manufacturing a polyurethane porous product, which includes the steps of (a) mixing a liquid curing agent that includes an active hydrogen group-containing compound, a silicon-based surfactant that includes a hydroxyl group, water that is a foaming promoter, and an abrasive; (b) injecting a non-reactive gas while the liquid mixture, an isocyanate group end urethane prepolymer and a solid curing agent that includes active hydrogen group-containing compound are agitated and mixed, and mixing them to form the mixture including a non-reactive gas; (c) molding a sheet by discharging and injecting the mixture including a non-reactive gas into a mold; (d) curing the molded sheet; and (e) forming a microhole on the cured sheet.

Preferably, the liquid curing agent of step (a) includes one or more compounds of an aromatic polyamine compound, an aliphatic amine-based compound, and a glycol compound that has a molecular weight of 250 or less.

In addition, the forming of the microhole in step (e) may include (e1) coating a solvent on the surface of the cured sheet; (e2) leaving the sheet on which the solvent is coated for 1 to 5 min; and (e3) drying the left sheet at a temperature of 80 to 100° C.

In addition, the aromatic polyamine compound includes dimethylthio toluenediamine, diethyl toluenediamine, 3,5-bis(methylthio)-2,4-toluenediamine, 3,5-bis(methylthio)-2,6-toluenediamine, 3,5-bis(methylthio)-2,4/2,6-toluenediamine, m-xylene, p-xylene, or 3,3-diethyl-4,4-diamino diphenylmethane, and the aliphatic amine-based compound includes diethanol amine, or triethanol amine, and the glycol compound that has the molecular weight of 250 or less includes diethylene glycol, triethylene glycol, or dipropylene glycol.

In addition, the coating of the solvent on the surface of the cured sheet in step (e1) may be performed by passing the cured sheet through gravure printing rolls to coat the solvent.

In addition, the solvent that is coated on the surface of the cured sheet may include one or more that are selected from dimethylformamide (DMF), dimethylacetamide (DMAc), dimethylsulfoxide (DMSO), ethyl acetate, and toluene.

In addition, the solid curing agent of step (b) includes one or more compounds that are selected from 4,4-methylenebis(o-chloroaniline), 2,6 dichloro-p-phenylenediamine, 4,4-methylenebis(2,6-diethylaniline), and 4,4-methylenebis(2,6-dimethylaniline).

In addition, the content of the liquid curing agent of step (a) is 10 to 70 parts by weight on the basis of 100 parts by weight of the total curing agent including the liquid curing agent and the solid curing agent.

In addition, the injection amount of the non-reactive gas of step (b) is 0.01 to 1.5 l/min on the basis of 1 kg/min of amount of the mixture including a non-reactive gas that is discharged.

In addition, the content of water that is the foaming promoter of step (a) is 0.001 to 3 parts by weight on the basis of 100 parts by weight of the isocyanate group end urethane prepolymer.

In addition, the non-reactive gas of step (b) includes any one of dried air, nitrogen, oxygen, and argon.

In addition, the content of the total curing agent that includes the liquid curing agent and the solid curing agent is 10 to 40 parts by weight on the basis of 100 parts by weight of the isocyanate group end urethane prepolymer.

In addition, the abrasive of step (a) has a particle diameter of 1 to 5 μm and includes any one of silica, cerium oxide, rare earth oxide, aluminum oxide, and barium oxide.

Meanwhile, the present invention provides a polyurethane porous product that is formed by using any one of the above methods.

Preferably, on the upper side of the polyurethane porous product, macrogrooves are formed in an X-Y axis orthogonal form, and microgrooves which have the depth that is different from that of the macrogroove are formed in an X-Y orthogonal.

In addition, the macrogroove has the depth of 0.3 to 1.5 mm, the width of 0.1 to 1.0 mm, and the pitch of 1.0 to 8.0 mm and the microgroove has the depth of 0.2 to 1.0 mm, the width of 0.1 to 0.5 mm, and the pitch of 1.0 to 5.0 mm.

In addition, the density of the polyurethane porous product is 0.5 to 0.95 g/cm³.

In addition, the hardness shore D of the polyurethane porous product is 40 to 80.

Meanwhile, the present invention provides a polishing pad which comprises the polyurethane porous product according to any one of claims 14 to 18; and a support pad that is attached to the lower side of the polyurethane porous product and supports the polyurethane porous product.

Preferably, the support pad is a non-woven fabric or polymer foam that has a smaller hardness and larger compressibility than the polyurethane porous product.

According to the present invention, it is possible to manufacture a polishing pad that has excellent polishing efficiency and has a minimal difference in the polishing characteristic during a polishing process and improves uniformity in plane of material that will be polished because the polyurethane porous product of the present invention has small density difference, small hardness difference, and the stabilized quality of material. In addition, there is an effect in which hardness and the size of the air hole of the polishing pad can be appropriately controlled and the productivity is excellent.

### BRIEF DESCRIPTION OF THE DRAWINGS

FIG. 1 is a cross-sectional view of a polyurethane porous product according to a preferred embodiment of the present invention;

FIG. 2 is a picture for a scanning electronic microscope of the polyurethane porous product according to a preferred embodiment of the present invention;

FIG. 3 is a flowchart that illustrates the manufacturing method of the polyurethane porous product of FIG. 1;

FIG. 4 illustrates the polyurethane porous product on which the groove is formed on surface; and

FIG. 5 is a cross-sectional view of a polishing pad that is formed by using the polyurethane porous product.

### DETAILED DESCRIPTION OF THE PREFERRED EMBODIMENTS

Hereinafter, the preferred Example according to the present invention will be described in detail with reference to the accompanying drawings. The application of the preferred embodiments of the present invention is best understood with reference to the accompanying drawings, wherein like reference numerals are used for like and corresponding parts, respectively. In addition, in the case of when the gist of the present invention is beside the point, the description thereof will be omitted. The present invention may, however, be embodied in many different forms and should not be construed as being limited to the Examples and Experimental Examples set forth herein. Rather, these Examples and Experimental Examples are provided such that this disclosure will be thorough and complete and will fully convey the concept of the present invention to those skilled in the art.

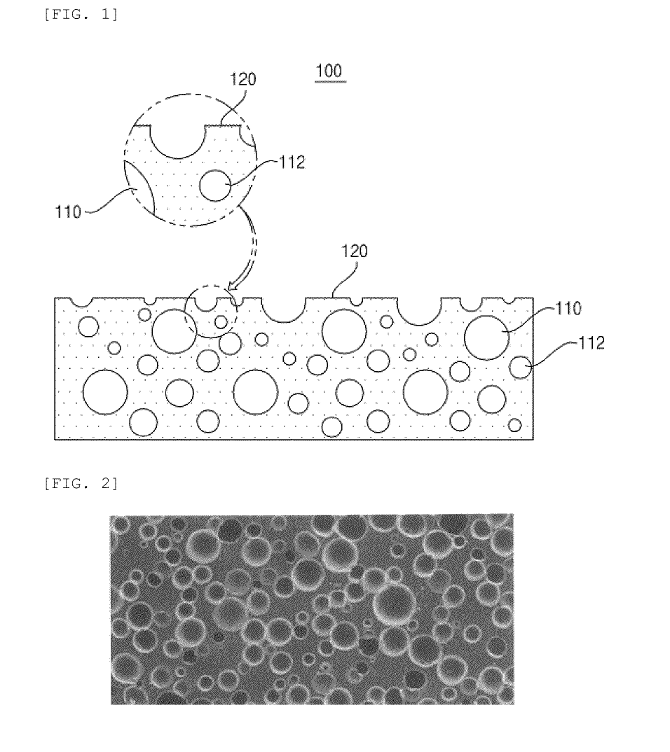

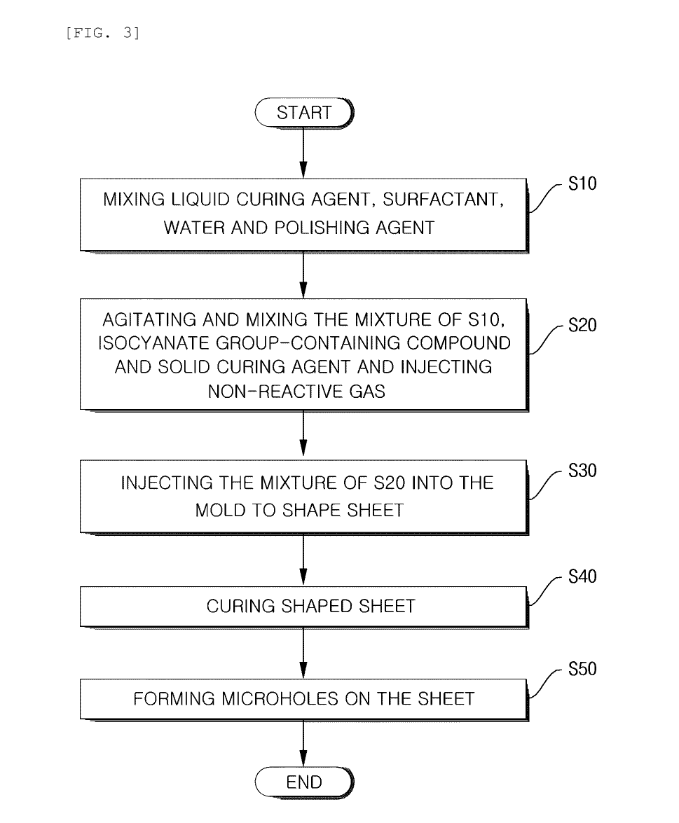

FIG. 1 is a cross-sectional view of a polyurethane porous product according to a preferred embodiment of the present invention, FIG. 2 is a photograph for a scanning electronic microscope of the polyurethane porous product according to a preferred embodiment of the present invention, and FIG. 3 is a flowchart that illustrates the manufacturing method of the polyurethane porous product of FIG. 1.

The polyurethane porous product 100 according to a preferred embodiment of the present invention is formed by mixing an isocyanate group end urethane prepolymer, a liquid curing agent, a solid curing agent, a surfactant, water and a polishing agent with each other. In the polyurethane porous product 100, as shown in FIGS. 1 and 2, fine air holes 110 and 112 are formed. In addition, microholes 120 that are finer than the air holes 110 and 112 are formed between the air holes 110 and 112.

Hereinafter, with reference to FIG. 3, the polyurethane porous product 100 and the manufacturing method thereof will be described in more detail.

First, a liquid curing agent, a surfactant, water and a polishing agent are weighed and mixed (S10).

Herein, the liquid curing agent is an active hydrogen group-containing compound, and may be any one or two or more selected from aromatic-based diamine compounds that are liquid at a normal temperature or have a melting point of 40° C. or less such as dimethylthio toluenediamine, diethyl toluenediamine, 3,5-bis(methylthio)-2,4-toluenediamine, 3,5-bis(methylthio)-2,6-toluenediamine, 3,5-bis(methylthio)-2,4/2,6-toluenediamine, m-xylene, p-xylene, and 3,3-diethyl-4,4-diaminodiphenylmethane.

In addition, it is a liquid curing agent and an active hydrogen group-containing compound, and may be any one or two or more selected from aliphatic amines that are liquid at a normal temperature such as diethanol amine and triethanol amine, or low molecular weight glycol compounds that have the molecular weight of 250 or less such as diethylene glycol, triethylene glycol, and dipropylene glycol.

As the liquid curing agent, the aromatic diamine-based compounds such as dimethylthio toluenediamine are more preferable. This is because in the case of when the aromatic diamine-based compound is used, it is relatively easy to control the reactivity and it is easy to obtain high hardness.

In addition, the content of the liquid curing agent that is liquid at a normal temperature or has the melting point of 40° C. or less is preferably 10 to 70 parts by weight on the basis of 100 parts by weight of the total curing agent including the liquid curing agent and the solid curing agent, and more preferably 20 to 45 parts by weight.

The surfactant lowers the surface tension of the polyurethane porous product 100 and make the size distribution of the air holes 110 and 112 uniform. As the surfactant, a silicon-based surfactant is preferable.

In particular, in the silicon-based surfactant that includes the hydroxyl group, the hydroxyl group-containing components such as propylene glycol, silicon glycol are present, and the hydroxyl group contributes to ensuring stability of the air holes 110 and 112 and is reacted with the isocyanate group end urethane prepolymer, such that the stable structure where the remaining surfactant does not move to the surface of the polyurethane porous product 100 during the manufacturing process or after the manufacturing process may be obtained.

In the case of the surfactant that does not include the hydroxyl group, the remaining surfactant moves to the surface of the polyurethane porous product 100 during the manufacturing process of the polyurethane porous product 100 or after the manufacturing process, thus negatively affecting planarization or polishing efficiency of the polyurethane porous product 100.

The content of the surfactant is 0.1 to 10 parts by weight, preferably 1 to 6 parts by weight, and more preferably 2 to 5 parts by weight on the basis of 100 parts by weight of the isocyanate group end urethane prepolymer. If the content of the surfactant is less than 0.1 parts by weight, it is difficult to form uniform air holes 110 and 112, and if the content is more than 10 parts by weight, an excessive amount of air holes 110 and 112 are formed, and the density and hardness of the polyurethane porous product 100 are lowered, thus reducing polishing properties.

Meanwhile, in a method for improving a maintaining amount of slurry that is injected during the polishing process and the wettability of the polyurethane porous product 100, water is added as a foaming promoter for forming a first air hole 110.

In step s10, water that is mixed with the liquid curing agent that includes the active hydrogen group is reacted with such as the isocyanate component in step S20 which will be described below to generate carbon dioxide, and the first air hole 110 is formed by carbon dioxide.

The first air hole 110 is provided in conjunction with the second air hole 112 that is formed by the non-reactive gas in step S20 in the polyurethane porous product 100, and the maintaining amount of slurry is increased by the first air hole 110 that is larger than the second air hole 112, thus improving the polishing efficiency.

It is preferable that the particle diameter of the first air hole 110 is 80 to 500 μm, and the number thereof is 1/10 to 1/20 as compared to the second air hole 112 that is formed by the non-reactive gas. In order to maintain the specific gravity, hardness and surface roughness, in the case of when the size of the first air hole 110 is controlled by water, it is preferable that excessively large air holes are filtered and removed by passing the mixture in step S20 through meshes before discharging.

The content of water that is the foaming promoter is 0.001 to 3 parts by weight, and preferably 0.01 to 0.5 parts by weight on the basis of 100 parts by weight of the isocyanate group end urethane prepolymer. If the content of water is less than 0.001 parts by weight, the number of first air holes 110 is decreased by water, and if the content of water is more than 3 parts by weight, since the number of first air holes 110 is very high, the hardness of the polyurethane porous product 100 is lowered and the surface thereof becomes rough, thus deteriorating uniformity in plane and planarization.

The polishing agent may be any one or two or more selected from cerium oxide, rare earth oxide, aluminum oxide, and fumed silica. The particle diameter of the polishing agent is preferably 1 to 5 μm and more preferably 1 to 3 μm.

It is preferable that the combination amount of the polishing agent is 3 to 40 parts by weight on the basis of 100 parts by weight of the isocyanate group end urethane prepolymer.

Preferably, the mixing is performed by additionally adding the catalyst in step S10.

The catalyst is to control the reactivity of the isocyanate group end urethane prepolymer, and may be any one or two or more of the amine-based catalyst and the metal-based catalyst.

As the amine-based catalyst, triethyl amine, bis(dimethyl amino ethyl ether), N,N-dimethyl cyclohexyl amine, tris(dimethyl amino propyl amine) and the like may be used, and as the metal-based catalyst, stannous octoate, dibutyltin dilaurate and the like are preferable.

In addition to the above-mentioned catalyst, various catalysts may be selected according to physical properties of the polyurethane porous product 100 which will be formed, and it is not limited thereto.

The content of the catalyst is 0.002 to 3 parts by weight, preferably 0.01 to 1 parts by weight, and more preferably 0.02 to 0.3 parts by weight on the basis of 100 parts by weight of the isocyanate group end urethane prepolymer. If the content of the catalyst is less than 0.002 parts by weight, the reaction is very slow, and if the content of the catalyst is more than 3 parts by weight, since the reaction of urethane is very quick, a pot life is short, such that the uniformity of products is lowered.

In step S10, in addition to the above-mentioned components, various additives may be further mixed according to the property of the polyurethane porous product 100 that will be formed.

In step S10, the solid curing agent is not added and the liquid curing agent surfactant, water and polishing agent are mixed with each other beforehand. The reason is because most solid curing agent has a melting point of 90° C. or more, and the viscosity can be controlled at a high temperature, such that a difference in temperature between the isocyanate group end prepolymer and the melted curing agent component is increased. If the temperature difference is increased, since a difference in size of the air hole occurs, and it is difficult to mix a predetermined amount of additive, catalyst, inorganic compound and the like, it is preferable that the liquid curing agent, the silicon-based surfactant, additive, catalyst, water and the like are mixed beforehand.

Subsequently, while the liquid mixture that is formed in step S10 is mixed with the isocyanate group end urethane prepolymer and solid curing agent and agitated, the non-reactive gas is injected and mixed therewith to form the mixture including the non-reactive gas (S20).

The isocyanate group end urethane prepolymer is a material that is obtained from the reaction of the isocyanate compound, polyol and a chain extender.

As the isocyanate compound, it is preferable to use toluene diisocyanate (TDI), but other diisocyanate compounds may be used unless the effect of the present invention is suppressed. Examples thereof include 4,4-diphenylmethanediisocyanate (MDI), xylene diisocyanate (XDI), isophoron diisocyanate (IPDI), and hydrogenated diphenylmethane diisocyanate (H12MDI).

Polyol may be any one of two or more selected from poly ether-based polyol that has a number average molecular weight of 200 to 1,500 such as poly(oxy tetramethylene)glycol, and poly(oxypropylene)glycol, and polycarbonate-based polyol, poly ester-based polyol and the like.

In the case of when the number average molecular weight is less than 200, excessive high hardness may occur and a scratch occurs because of strong brittleness, and in the case of when the number average molecular weight is more than 1,500, since the hardness of the polyurethane porous product 100 is lowered, the polishing rate and planarization property may be deteriorated.

The chain extender may be any one or two or more selected from low molecular weight polyol such as ethyleneglycol, 1,2-propyleneglycol, 1,3-propyleneglycol, 1,4-butandiol, neopentinglycol, 1,5-pentandiol, 1,6-hexanediol, diethyleneglycol, and dipropyleneglycol.

The NCO wt % of isocyanate end urethane prepolymer is preferably 6 to 12 NCO wt % and more preferably 8 to 10 NCO wt %. If the NCO wt % is very high, since high hardness is obtained, the planarization property is increased but uniformity in plane is lowered and a scratch occurs.

The solid curing agent is a compound that includes an active hydrogen group, and an aromatic diamine-based compound that is solid at a normal temperature may be used. For example, as the curing agent that is solid at a normal temperature, materials having a melting point of 80° C. or more such as 4,4-methylenebis(o-chloroaniline), 2,6 dichloro-p-phenylenediamine, 4,4-methylenebis(2,6-diethylaniline), and 4,4-methylenebis(2,6-dimethylaniline) may be used. Among them, most preferably, 4,4-methylenebis(o-chloroaniline) is used.

The content of the solid curing agent is 30 to 90 parts by weight and preferably 55 to 80 parts by weight on the basis of 100 parts by weight of the total curing agent that includes the liquid curing agent and the solid curing agent. In the case of when the content of the solid curing agent is less than 30 parts by weight, hardness to the same density is small and the durability is lowered as compared to the polyurethane porous product 100 using only the solid curing agent, the polishing efficiency and the durability are poor. Meanwhile, in the case of when the content of the solid curing agent is more than 90 parts by weight, when the surfactant, additive and polishing agent components are mixed, the production efficiency is lowered and a scratch easily occurs because of high elasticity.

While the liquid mixture of step S10, the isocyanate group end urethane prepolymer, and solid curing agent are mixed and reacted in the high rate agitation & injection apparatus, the non-reactive gas is continuously injected and mixed in an amount of 0.01 to 1.5 l/min on the basis of 1 kg/min of amount of the mixture including a non-reactive gas that is discharged. Preferably, it is 0.1 to 0.8 l/min on the basis of 1 kg/min of amount of the mixture including a non-reactive gas that is discharged. The non-reactive gas is to form the second air hole 112 in the polyurethane porous product 100, and if the injection amount of the non-reactive gas is less than 0.01 l/min, the number of second air holes 112 is very small, and if the injection amount of the non-reactive gas is more than 1.5 l/min, since the number of second air holes 112 is very large, the hardness of the polyurethane porous product 100 is low and uniformity in plane and planarization are lowered. The size of the air hole of the polyurethane porous product 100 that is formed by injecting the non-reactive gas is average 20 to 70 μm and preferably 30 to 60 μm.

At this time, as the injected non-reactive gas, gas that does not affect the chemical reaction of the compound and includes dry air, nitrogen, oxygen, argon and the like is used, and nitrogen is preferable in views of the operation process.

When they are mixed by using the high rate agitation & injection apparatus, it is preferable that the temperature of the isocyanate group end urethane prepolymer, the liquid curing agent that includes the active hydrogen compound and the solid curing agent is within the scope that does not affect the chemical reaction in the high rate agitation & injection apparatus. In detail, it is preferable that the temperature of the isocyanate group end prepolymer is controlled within the range of 30 to 80° C. and in particular, it is 50 to 70° C. in order to easily control the viscosity of the isocyanate group end prepolymer.

As described above, the agitated mixture to which the non-reactive gas is injected is discharged from the high rate agitation & injection apparatus and injected into the mold to form a sheet (S30), and the shaped sheet is cured in the hot oven (S40).

Next, microholes 120 are formed by passing the sheet through the gravure printing rolls and drying it (S50). The polyurethane porous product 100 may be used after being cut in a predetermined thickness.

Herein, the microhole 120 functions to improve the wettability of the polyurethane porous product 100 while physical properties of the polyurethane porous product 100 are not basically lowered. The microhole 120 may be formed on the surface of the polyurethane porous product 100 by passing it through the gravure printing rolls.

In more detail, on the surface of the polyurethane porous product 100 that is cured in a sheet form, the dimethylformamide (DMF) solution and the like are coated by using the gravure printing roll having 200 mesh or less, left for 1 to 5 min to finely dissolve its surface and dried at 80 to 100° C. to form the microholes 120.

Thereby, the microholes 120 of about 3 μm or less are formed between the air holes 110 and 112 that are formed by the non-reactive gas and water, thus improving the absorptivity of slurry. At this time, as the solvent that forms the microholes 120, solvents such as dimethylformamide (DMF), dimethylacetamide (DMAc), dimethylsulfoxide (DMSO), toluene and the like may be used, and it is preferable to use dimethylformamide in views of the operation process.

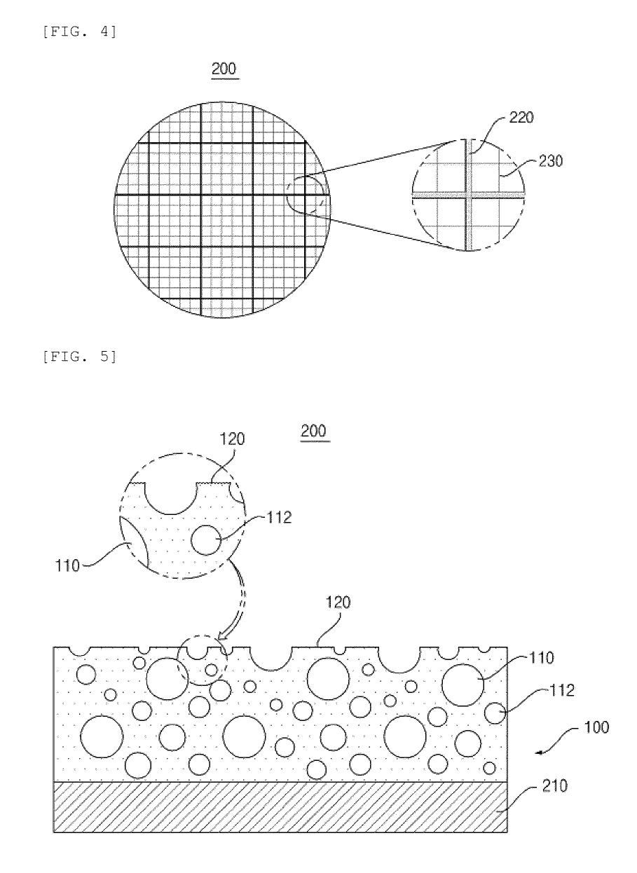

Meanwhile, grooves 220 and 230 as shown in FIG. 4 may be formed on the upper side of the polyurethane porous product 100 that is manufactured through steps S10 to S50 in order to obtain uniform fluidity and distribution of slurry that is provided during the polishing process, that is, in order to minimize a loss of slurry and uniformly distribute the slurry on the surface.

The grooves 220 and 230 include the macrogroove 220 that is formed on the upper side of the polyurethane porous product 100 in an X-Y axis orthogonal form and the microgroove 230 that is formed in an X-Y orthogonal form between the macrogrooves 220 and have the depth that is different from that of the macrogroove 220.

In some cases, any one of the macrogroove 220 or the microgroove 230 may be formed, but preferably both the macrogroove 220 and the microgroove 230 that are disposed between the macrogrooves are formed.

The macrogroove 220 has the depth of 0.3 to 1.5 mm, the width of 0.1 to 1.0 mm, and the pitch of 1.0 to 8.0 mm and the microgroove 230 has the depth of 0.2 to 1.0 mm, the width of 0.1 to 0.5 mm, and the pitch of 1.0 to 5.0 mm.

Meanwhile, the density of the polyurethane porous product 100 that is manufactured through steps S10 to S50 is 0.5 to 0.95 g/cm³ and preferably 0.7 to 0.9 g/cm³. In addition, it is preferable that the hardness shore D of the polyurethane porous product 100 that is important in views of polishing efficiency, uniformity in plane, and planarization of the wafer during the polishing process is 40 to 80 and particularly preferably 50 to 65.

If the hardness shore D is less than 40, the possibility of occurrence of a scratch is lowered, but uniformity in plane, planarization and polishing efficiency are lowered, and if the hardness shore D is more than 80, uniformity in plane, planarization are improved, but the possibility of occurrence of a scratch is increased.

The polishing pad 200 as shown in FIG. 5 may be formed by attaching the support pad 210 to the lower side of the polyurethane porous product 100 that is formed through steps S10 to S50.

Herein, as the support pad 210, a non-woven fabric or a polymer foam that supports the polyurethane porous product 100 is attached. The support pad 210 is the non-woven fabric or polymer foam that has the smaller hardness and more compressibility than the polyurethane porous product, and it is preferable to use the non-woven fabric that includes the support pad 210 having the compressibility of 5 to 15%, compression elasticity of 55 to 75%, and hardness Shore A of 60 to 78.

Hereinafter, through Examples and Comparative Examples, a characteristic of the polishing pad 200 according to the present invention will be described.

<Polishing Characteristic Evaluation Method>

1. The thickness of the material that will be polished is measured before and after the test by performing the polishing test for 1 min. 49 measurement positions on the polishing surface are determined beforehand. The average value in respects to a difference in thickness before and after the polishing test of the 49 measurement positions is calculated and set as the polishing rate in respects to one polishing pad.

2. The average value A of polishing rates and the dispersion value B of 10 polishing pads including the same fine air holes are represented by A±B to evaluate the polishing property and a difference between lots. A relates to the polishing property, and the higher the value of A is, the better the polishing efficiency is. B relates to a difference in lots, and the lower the value of B is, the better the polishing efficiency is.

### Comparative Example 1

After 1 part by weight of silicon-based non-ionic surfactant [trademark: SH-192] that did not include the hydroxyl group was added to 100 parts by weight of the isocyanate group end urethane prepolymer [Adiprene L-325 (NCO 9.2%)] and mixed, the non-reactive gas was provided to the mixer, and they were agitated at a high rate of about 900 rpm to obtain a cream type bubble dispersion solution. After the nonuniform bubbles were removed by passing the bubble dispersion solution through the filtering net, it was transported to the high rate mixer, 26.2 parts by weight of methylene bis-o-chloroaniline [MBCA, Ihara Chemical, Co., Ltd.] that was dissolved at 120° C. was mixed therewith, they were injected into the mold, and cured at 80 to 85° C. for about 12 hours. The polyurethane porous product was manufactured by cooling the molded structure to 25° C. and slicing it in a thickness of 1.27 mm.

In order to efficiently control the provision amount of slurry between the surface of the polyurethane porous product and the wafer and increase the polishing efficiency, the grooves were formed on the surface of the polyurethane porous product. To the upper side of the polyurethane porous product in which on the upper side of the polyurethane porous product, macrogrooves that are formed in an X-Y axis orthogonal form and microgrooves that have the width and depth that are different from those of the macrogroove, the non-woven fabric that included urethane and had the thickness of 1.25±0.03 mm, compressibility of 10±3, and hardness Shore A of 70±2 was attached, thus manufacturing the polishing pad.

The polishing pad that was manufactured according to the above method was provided to the polishing device to evaluate the polishing property of the SiO₂ film. The polishing was performed under the polishing condition of the inflow amount of 150 ml/min, the wafer load of 5.5 psi, the turn table revolving number of 30 rpm, and the polishing time of 60 sec.

### Comparative Example 2

3 parts by weight of the silicon-based non-ionic surfactant [trademark: SH-192] that did not include the hydroxyl group was added to 100 parts by weight of the isocyanate group end urethane prepolymer [Adiprene L-325 (NCO 9.2%)] and mixed, and they were defoamed under reduced pressure. The non-reactive gas was provided to the mixer and agitated at the high rate of about 900 rpm for about 4 min to obtain the cream type bubble dispersion solution. After the nonuniform bubbles were removed by passing the bubble dispersion solution through the filtering net, it was transported to the high rate mixer, 21 parts by weight of 3,5-bis(methylthio)-2,4/2,6-toluenediamine [trademark: Etacure 300, manufactured by Albemer Co., Ltd.], of which the temperature was controlled to 70° C. was mixed therewith, they were injected into the mold, and cured at about 100° C. for about 12 hours. The polyurethane porous product was manufactured by cooling the molded structure to 25° C. and slicing it in a thickness of 1.27 mm.

Next, after the groove was formed by using the same method as Comparative Example 1, the polishing pad was manufactured, and the polishing was performed under the same polishing condition as Comparative Example 1.

### Example 1

After 3 part by weight of silicon-based non-ionic surfactant [trademark: SH-193] that included the hydroxyl group was added to 100 parts by weight of the isocyanate group end urethane prepolymer [Adiprene L-325 (NCO 9.2%)] and mixed, they were mixed, reacted, and defoamed at about 70° C. for 2 hours. After the reaction solution was transported to the air nucleation type of the high rate agitation & injection apparatus, while 24 parts by weight of the solid curing agent [MOCA] that was dissolved beforehand in 120° C. was added, the N₂ gas that was the non-reactive gas was supplied by using the mass flow meter and mixed therewith under the process condition of the injection amount of the N₂ gas of 0.5 l/min, the discharge amount of the mixture including a non-reactive gas of 5 kg/min, the N₂ gas supply pressure of 5 bar, and the agitation rate of the high rate agitation & injection apparatus of 5,000 rpm, and the discharged mixture was injected into the mold and cured at 100° C. for 12 hours. After the molded structure was cooled to 25° C., the polyurethane porous product that had the same thickness as that of Comparative Example 1 was manufactured.

Next, after the groove was formed by using the same method as Comparative Example 1, the polishing pad was manufactured, and polishing was performed under the same polishing condition as Comparative Example 1.

### Example 2

After the polyurethane porous product was manufactured by using the same process as Example 1, the microhole was formed by coating the dimethylformamide (DMF) solution on the surface thereof using the gravure printing roll of 200 mesh, leaving it for 2 min, and drying it at 80° C. Thereafter, the polishing pad was manufactured by performing the slicing process through the same method as Comparative Example 1.

Next, after the groove was formed by using the same method as Comparative Example 1 on the polyurethane porous product, the polishing pad was manufactured, and the polishing was performed under the same polishing condition as Comparative Example 1.

### Examples 3 to 6

After the silicon-based surfactant and the liquid curing agent [Etacure-300] were mixed and defoamed at 40° C. for 1 hour and transported to the high rate agitation & injection apparatus, the isocyanate group end urethane prepolymer and the solid curing agent [MOCA] were added thereto and mixed, and simultaneously the N₂ gas was injected thereto and mixed therewith. Also, the mixture including the N₂ gas was discharged and injected into the mold. Thereafter, the polishing pad was manufactured by using the same method as Example 1, and the combination amount of each component is described in the following Table 1.

TABLE 1

| | | | | | Mass | | |
|---|---|---|---|---|---|---|---|
| | | Curing agent | | | flow | | |
| | | (parts by | | | meter | | |
| | Urethane | weight) | | | control | Agitation | |
| | prepolymer | | Etacure- | | (N₂ gas | rate | Gravure |
| | (L-325) | MOCA | 300 | Surfactant | amount) | (rpm) | printing |
| Comparative | 100 | 26.2 | — | DC 192 1 | — | 900 | X |
| Example 1 | | | | | | | |
| Comparative | 100 | — | 21 | DC 192 3 | — | 900 | X |
| Example 2 | | | | | | | |
| Example 1 | 100 | 25 | — | DC 193 3 | 0.5 l/min | 5,000 | X |
| Example 2 | 100 | 25 | — | DC 193 3 | 0.5 l/min | 5,000 | X |
| Example 3 | 100 | 20 | 4.3 | DC 193 3 | 0.5 l/min | 5,000 | ◯ |
| Example 4 | 100 | 13.2 | 10.5 | DC 193 3 | 0.5 l/min | 5,000 | X |
| Example 5 | 100 | 8.0 | 14.8 | DC 193 3 | 0.5 l/min | 5,000 | X |
| Example 6 | 100 | 13.2 | 10.5 | DC 193 3 | 0.5 l/min | 5,000 | ◯ |

The results of the physical properties and the polishing characteristics of the polishing pad according to Comparative Examples and Examples of Table 1 are described in the following Table 2.

TABLE 2

| | | Comparative | Comparative | | | | | | |
|---|---|---|---|---|---|---|---|---|---|
| | | Example 1 | Example 2 | Example 1 | Example 2 | Example 3 | Example 4 | Example 5 | Example 6 |
| Specific | | 0.86 | 0.88 | 0.85 | 0.84 | 0.84 | 0.83 | 0.83 | 0.83 |
| gravity | | | | | | | | | |
| Shore D | | 56 | 52 | 58 | 57 | 56 | 56 | 54 | 55 |
| hardness | | | | | | | | | |
| Compressibility | | 1.4 | 2.1 | 1.6 | 1.7 | 1.7 | 1.8 | 2.0 | 1.9 |
| Average air | | 30 to | 35 to | 30 to | 30 to | 35 to | 35 to | 35 to | 30 to |
| hole (μm) | | 50 | 50 | 50 | 50 | 50 | 50 | 50 | 50 |
| Polishing | initial | 2850 | 2810 | 2960 | 2980 | 2960 | 2950 | 2880 | 2980 |
| rate | 100 | 2780 | 2740 | 2890 | 2920 | 2880 | 2860 | 2820 | 2930 |
| Å/min | pads | | | | | | | | |
| | 300 | 2710 | 2670 | 2840 | 2850 | 2810 | 2780 | 2730 | 2850 |
| | pads | | | | | | | | |
| Uniformity | initial | 5.8 or | 6.0 or | 3.9 or | 4.0 or less | 4.2 or | 4.3 or | 4.5 or | 4.3 or |
| in | | less | less | less | | less | less | less | less |
| plane | | | | | | | | | |
| (%) | 100 | 6.7 or | 7.2 or | 4.8 or | 4.7 or | 5.0 or | 5.2 or | 5.4 or | 5.0 or |
| | pads | less | less | less | less | less | less | less | less |
| | 300 | 7.4 or | 7.9 or | 5.6 | 5.4 | 5.7 or | 6.0 or | 6.2 or | 5.8 or |
| | pads | less | less | or | or | less | less | less | less |
| | | | | less | less | | | | |

| | | | | | | | | |
|---|---|---|---|---|---|---|---|---|
| Cell shape | good | good | good | good | Very | Very | Very | Very |
| density | | | | | excellent | excellent | excellent | excellent |

As shown in Table 2, Examples 1 to 6 where the second air holes are formed by using the non-reactive gas improves the polishing rate and uniformity in plane as compared to Comparative Examples 1 to 2. In addition, it can be seen that Examples 3 to 4 where the liquid curing agent is added provides excellent cell shape density as compared to the other cases.

Meanwhile, in order to test the polishing characteristic of the polishing pad that is manufactured by adding water and the polishing agent as the foaming promoter, Examples 7 to 11 were performed.

### Examples 7 to 11

reactive gas was supplied by using the mass flow meter and mixed therewith under the process condition of the injection amount of the N₂ gas of 0.5 l/min, the discharge amount of the mixture including a non-reactive gas of 5 kg/min, the N₂ gas supply pressure of 5 bar, and the agitation rate of the high rate agitation & injection apparatus of 5,000 rpm, and the discharged mixture

The N2 gas that was the non-reactive gas was injected in an amount of 0.4 l/min, the N₂ gas supply pressure was 3 bar, the discharge amount of the mixture including a non-reactive gas was 5 kg/min, the agitation rate of the high rate agitation & injection apparatus was 5,000 rpm, and 3 parts by weight of the reactive silicon-based surfactant (DC-193) was added on the basis of 100 parts by weight of the isocyanate group end urethane prepolymer. In addition to this, the polishing pad was manufactured by using the same method as Example 1, and the combination amount of components such as water and the polishing agent are described in the following Table 3.

TABLE 3

| | | | | | | | Abrasive | |
|---|---|---|---|---|---|---|---|---|
| | | | | Mass | | | (particle | |
| | Urethane | Curing agent | | flow | Water | Catalyst | diameter | |
| | prepolymer | (parts by | | meter | content | 33LV | 1.5 μm | |
| | (L- | weight) | | control | (parts | (parts | silica) | |
| | 325/parts | | Etacure- | (N₂ gas | by | by | (parts by | Gravure |
| | by weight) | MOCA | 300 | amount) | weight) | weight) | weight) | printing |
| Comparative | 100 | 26.2 | — | — | — | — | X | X |
| Example 1 | | | | | | | | |
| Comparative | 100 | — | 21 | — | — | — | X | X |
| Example 2 | | | | | | | | |
| Example 6 | 100 | 20 | 4.3 | 0.4 | 0.03 | 0.05 | X | X |
| Example 7 | 100 | 20 | 4.3 | 0.4 | 0.03 | 0.05 | X | ◯ |
| Example 8 | 100 | 13.2 | 10.5 | 0.4 | 0.03 | 0.05 | X | X |
| Example 9 | 100 | 13.2 | 10.5 | 0.4 | 0.03 | 0.05 | X | ◯ |
| Example 10 | 100 | 13.2 | 10.5 | 0.4 | 0.03 | 0.05 | 3 | X |
| Example 11 | 100 | 13.2 | 10.5 | 0.4 | 0.03 | 0.05 | 3 | ◯ |

In order to test the polishing characteristic in respects to Examples 7 to 11 of Table 3, polishing was performed under the same polishing condition as Comparative Example 1. The results are described in the following Table 4.

TABLE 4

| | | Comparative | Comparative | | | | | Example | Example |
|---|---|---|---|---|---|---|---|---|---|
| | | Example 1 | Example 2 | Example 6 | Example 7 | Example 8 | Example 9 | 10 | 11 |
| Specific | | 0.86 | 0.83 | 0.83 | 0.83 | 0.82 | 0.82 | 0.82 | 0.82 |
| gravity | | | | | | | | | |
| Shore D | | 56 | 52 | 54 | 54 | 53 | 53 | 52 | 52 |
| hardness | | | | | | | | | |
| Compressibility | | 1.4 | 2.1 | 1.8 | 1.9 | 1.9 | 2.0 | 2.1 | 2.2 |
| Average air | | 30 to 50 | 35 to 50 | 35 to | 35 to | 35 to | 35 to | 35 to | 35 to |
| hole (μm) | | | | 50/90 | 50/90 | 50/90 | 50/90 | 50/90 | 50/90 |
| | | | | to 150 | to 150 | to 150 | to 150 | to 150 | to 150 |
| Polishing | initial | 2850 | 2810 | 2980 | 3000 | 2960 | 2970 | 3000 | 3020 |
| rate | 100 | 2780 | 2740 | 2890 | 2920 | 2870 | 2900 | 2940 | 2960 |
| Å/min | pads | | | | | | | | |
| | 300 | 2710 | 2670 | 2830 | 2850 | 2800 | 2840 | 2870 | 2910 |
| | pads | | | | | | | | |
| Uniformity | initial | 5.8 or | 6.0 or | 4.5 or | 4.6 or | 4.7 or | 4.7 or | 4.9 or | 5.0 or |
| in | | less | less | less | less | less | less | less | less |
| plane | 100 | 6.7 or | 7.2 or | 5.3 or | 5.5 or | 5.8 or | 5.8 or | 5.7 or | 5.6 or |
| (%) | pads | less | less | less | less | less | less | less | less |
| | 300 | 7.4 or | 7.9 or | 5.9 or | 6.2 or | 6.5 or | 6.3 or | 6.2 or | 6.0 or |
| | pads | less | less | less | less | less | less | less | less |

| | | | | | | | | |
|---|---|---|---|---|---|---|---|---|
| Cell shape | good | good | good | good | good | good | good | good |
| density | | | | | | | | |

As shown in Table 4, in Examples 7 to 11 where water is added as the foaming promoter, the first air hole having the particle diameter of 90 to 150 μm and the second air hole having the particle diameter of 35 to 50 μm are formed together, and the polishing rate and the uniformity in plane are improved as compared to Comparative Examples 1 to 2.

As described above, as shown in Tables 2 and 4, the polishing pad where the microhole is formed by appropriately controlling and changing the mixing ratio of the curing agent, the content of the non-reactive gas, the content of water, the content of the polishing agent and the like according to the present invention shows properties such as a minimal difference in polishing properties and excellent polishing efficiency and uniformity in plane according to the polishing process.

In the above detailed description, only certain exemplary embodiments of the present invention have been shown and described, simply by way of illustration. As those skilled in the art would realize, the described embodiments may be modified in various different ways, all without departing from the spirit or scope of the present invention. This invention may, however, be embodied in many different forms and should not be construed as being limited to the embodiments set forth herein; rather, these embodiments are provided so that this disclosure will be thorough and complete, and will fully convey the concept of the invention to those of ordinary skill in the art. Therefore, it is to be understood that within the scope of the appended claims, the invention may be practiced otherwise than as specifically described.

What is claimed is:

1. A method for manufacturing a polyurethane porous product, the method comprising the steps of:
(a) mixing the liquid curing agent that includes an active hydrogen group-containing compound, a silicon-based surfactant that includes a hydroxyl group, water that is a foaming promoter, and an abrasive;
(b) injecting a non-reactive gas while the above liquid mixture, an isocyanate group end urethane prepolymer and a solid curing agent that includes active hydrogen group-containing compound are agitated and mixed, and mixing them to form the mixture including a non-reactive gas;
(c) molding a sheet by discharging and injecting the mixture including a non-reactive gas into a mold;
(d) curing the molded sheet; and
(e) forming a microhole on the cured sheet.

2. The method for manufacturing a polyurethane porous product as set forth in claim 1, wherein the liquid curing agent of step (a) includes one or more compounds of an aromatic polyamine compound, an aliphatic amine-based compound, and a glycol compound that has a molecular weight of 250 or less.

3. The method for manufacturing a polyurethane porous product as set forth in claim 1, wherein the forming of the microhole in step (e) includes:
(e1) coating a solvent on the surface of the cured sheet;
(e2) leaving the sheet on which the solvent is coated for 1 to 5 min; and
(e3) drying the left sheet at a temperature of 80 to 100° C.

4. The method for manufacturing a polyurethane porous product as set forth in claim 2, wherein the aromatic polyamine compound includes dimethylthio toluenediamine, diethyl toluenediamine, 3,5-bis(methylthio)-2,4-toluenediamine, 3,5-bis(methylthio)-2,6-toluenediamine, 3,5-bis(methylthio)-2,4/2,6-toluenediamine, m-xylene, p-xylene, or 3,3-diethyl-4,4-diamino diphenylmethane, and the aliphatic amine-based compound includes diethanol amine, or triethanol amine, and the glycol compound that has the molecular weight of 250 or less includes diethylene glycol, triethylene glycol, or dipropylene glycol.

5. The method for manufacturing a polyurethane porous product as set forth in claim 3, wherein the coating the solvent on the surface of the cured sheet in step (e1) is performed by passing the cured sheet through gravure printing rolls to coat the solvent.

6. The method for manufacturing a polyurethane porous product as set forth in claim 5, wherein the solvent that is coated on the surface of the cured sheet includes one or more that are selected from dimethylformamide (DMF), dimethylacetamide (DMAc), dimethylsulfoxide (DMSO), ethyl acetate, and toluene.

7. The method for manufacturing a polyurethane porous product as set forth in claim 1, wherein the solid curing agent of step (b) includes one or more compounds that are selected from 4,4-methylenebis(o-chloroaniline), 2,6 dichloro-p-phenylenediamine, 4,4-methylenebis(2,6-diethylaniline), and 4,4-methylenebis(2,6-dimethylaniline).

8. The method for manufacturing a polyurethane porous product as set forth in claim 1, wherein the content of the liquid curing agent of step (a) is 10 to 70 parts by weight on the basis of 100 parts by weight of the total curing agent including the liquid curing agent and the solid curing agent.

9. The method for manufacturing a polyurethane porous product as set forth in claim 1, wherein the injection amount of the non-reactive gas of step (b) is 0.01 to 1.5 l/min on the basis of 1 kg/min of amount of the mixture including a non-reactive gas that is discharged.

10. The method for manufacturing a polyurethane porous product as set forth in claim 1, wherein the content of water that is the foaming promoter of step (a) is 0.001 to 3 parts by weight on the basis of 100 parts by weight of the isocyanate group end urethane prepolymer.

11. The method for manufacturing a polyurethane porous product as set forth in claim 1, wherein the non-reactive gas of step (b) includes any one of dried air, nitrogen, oxygen, and argon.

12. The method for manufacturing a polyurethane porous product as set forth in claim 1, wherein the content of total curing agent that includes the liquid curing agent and the solid curing agent is 10 to 40 parts by weight on the basis of 100 parts by weight of the isocyanate group end urethane prepolymer.

13. The method for manufacturing a polyurethane porous product as set forth in claim 1, wherein the abrasive of step (a) has a particle diameter of 1 to 5 μm and includes any one of silica, cerium oxide, rare earth oxide, aluminum oxide, and barium oxide.

14. A polyurethane porous product that is formed by using the method according to claim 1.

15. The polyurethane porous product as set forth in claim 14, wherein on the upper side of the polyurethane porous product, macrogrooves are formed in an X-Y axis orthogonal form, and microgrooves which have the depth that is different from that of the macrogroove are formed in an X-Y orthogonal.

16. The polyurethane porous product as set forth in claim 15, wherein the macrogroove has the depth of 0.3 to 1.5 mm, the width of 0.1 to 1.0 mm and the pitch of 1.0 to 8.0 mm and the microgroove has the depth of 0.2 to 1.0 mm, the width of 0.1 to 0.5 mm, and the pitch of 1.0 to 5.0 mm.

17. The polyurethane porous product as set forth in claim 14, wherein the density of the polyurethane porous product is 0.5 to 0.95 g/cm³.

18. The polyurethane porous product as set forth in claim 14, wherein the hardness shore D of the polyurethane porous product is 40 to 80.

19. A polishing pad comprising:
the polyurethane porous product according to claim 14; and
a support pad that is attached to the lower side of the polyurethane porous product and supports the polyurethane porous product.

20. The polishing pad as set forth in claim 19, wherein the support pad is a non-woven fabric or polymer foam that has a smaller hardness and larger compressibility than the polyurethane porous product.
